(19) United States
(12) Patent Application Publication
(10) Pub. No.: US 2002/0130885 A1
(43) Pub. Date: Sep. 19, 2002

(54) Color conversion method of light emitting pointer for vehicle dashboard, color conversion device therefor and light emitting pointer device using the same

(75) Inventor: Chang-heon Lee, Tongrae-ku (KR)

Correspondence Address: EZRA SUTTON, P.A., Plaza 9, 900 Route 9, Woodbridge, NJ, 07095, US

(73) Assignee: Unick Corporation

(21) Appl. No.: 09/808,670

(22) Filed: Mar. 14, 2001

(51) Int. Cl. G09G 5/02; G09G 5/10

(52) U.S. Cl. 345/600

(57) ABSTRACT

The present invention relates to a color conversion method of a light emitting pointer for a vehicle dashboard, a color conversion device therefor and a light emitting pointer using the same. The color conversion method comprises the steps of: disposing three light sources having three colors arranged at equal intervals on the circumferences thereof centering around the axis of the pointer; and controlling the switching of the respective light sources by means of a light source operation controller, such that the light of the three colors from the respective light sources is emitted for predetermined time on the different time, whereby the combination of the three colors using the afterimage of the eyes is induced to thus obtain various colors. Therefore, the pointer exhibits various kinds of color variations, upon operation, as the light receiving prism and the light sources of three colors emit the respective light in a sequential order on respective corresponding time by on/off combination of the colors in a time-division manner using the afterimage of eyes, thereby improving the recognition of the vehicle state and enhancing a level of the vehicle.

### BACKGROUND OF THE INVENTION

1. Field of the Invention

The present invention relates to a color conversion method of a light emitting pointer for a vehicle dashboard, a color conversion device therefor and a light emitting pointer using the same. More particularly, the present invention relates to a color conversion method of a light emitting pointer for a vehicle dashboard, a color conversion device therefor and a light emitting pointer using the same, where the pointer exhibits various kinds of color variations, upon operation, as a light receiving prism and light sources of three colors emit the respective light in a sequential order on respective corresponding time by on/off combination of the colors in a time-division manner using the afterimage of eyes, thereby improving the recognition of a vehicle state and enhancing the level of the vehicle.

2. Description of the Related Art

Generally, a dashboard for a vehicle is used to indicate the driving state such as a running speed, revolution per minute, an amount of oil supplied, an engine temperature and so on and the operations of other vehicle accessories, for the purpose of enabling easy recognition of a driver, such that the driver can safely drive the vehicle. Further, the dashboard is used, for the purpose of making the current state of the vehicle immediately be recognized for a previous maintenance and check, such that any accidents can be previously prevented.

Specifically, the driver should clearly recognize the driving state of the vehicle during driving at night, and for this end, there is required an installation of a lighting device on the pointer of the general dashboard. That is, the general vehicle dashboard attaches a rotation speedometer indicating the speed of the vehicle, an oil pressure gauge, a fuel gauge and a mercury meter thereon. And, the respective pointers are disposed on the character panel indicated with various kinds of characters, figures and indication graduations thereon. In addition, the general vehicle dashboard is provided with a prism that is adapted to reflect a light projected from light sources to the pointer to thereby emit the light through the pointer, and a motor that rotates the pointer, on the back surface thereof.

If a starting switch is turned on, the meter devices on the general vehicle dashboard operate at once and are set to exhibit a predetermined single color in accordance with the color of a cap covering the lighting or the characteristics of fluorescence thereof.

The meter devices with the single color may cause visual fatigue of the driver or provide tediousness to him, especially when he drives at night for a long time, thereby accidents may happen due to the lack of carefulness.

To solve such problems, there is proposed Korean Patent Application No. 9631500 entitled “meter cluster pointer lighting device for vehicle”, where the colors of the pointers of respective meters of the vehicle are set to be varied with two or more colors in accordance with the preference of the driver.

The pointer lighting device of the prior art is configured of a light emitting part having at least two or more light emitting diodes emitting different colors and at least two or more transistors, a lighting selection switch selectively connecting power of the vehicle with the light emitting part, and a DC/DC converter connected in parallel with each light emitting diode of the light emitting part and for dropping the power of the vehicle to a driving voltage of the light emitting part, thereby supplying a stable driving voltage to the light emitting part.

Under the above construction, if a driver is to convert the color of the pointer into the color emitted from a predetermined light emitting diode, he selects the lighting selection switch. Thereby, the corresponding transistor is turned on by the driving voltage applied from the converter and thus, the light of his desired color is emitted from the predetermined light emitting diode. And, the light is projected to the outside through a prism, such that he can obtain the pointer having his desired color.

With the conventional pointer lighting device, however, a predetermined number of light emitting diodes ought to be provided in order to create the predetermined number of colors, which means the number of transistors and accessories corresponding to the predetermined number of light emitting diodes are also needed. Of course, this causes the structure of the pointer lighting device to be rather complicated, thereby making it difficult to manufacture the device. Furthermore, the increased number of light emitting diodes causes the production cost being raised, and the colors of the light emitting diodes are really limited, thereby the driver does not fully meet his taste in the pointer.

Additionally, since the color of the pointer is kept up without any continuous variation, the driver is likely to feel tedious.

On the other hand, even if a color embodying method where the light emitting diodes of three colors having a brightness adjusted at different rates are used is applied, the structure of each pointer is technically or manufacturally not allowed, thereby the lights of each light source are not condensed well to one spatial point, which makes it difficult to have a uniform color. Also, an observation point should be distant from the light source, but since the technology still has various limitations, the embodiment is impossible in a limited space, particularly in the pointer for the vehicle dashboard.

### SUMMARY OF THE INVENTION

Accordingly, it is an object of the present invention to provide a color conversion method of a light emitting pointer for a vehicle dashboard, a color conversion device therefor and a light emitting pointer using the same, where the pointer exhibits various kinds of color variations, upon operation, as a light receiving prism and light sources of three colors emit the respective light in a sequential order on respective corresponding time by on/off combination of the colors in a time-division manner using the afterimage of eyes, thereby improving the recognition of the vehicle state and enhancing a level of the vehicle.

According to an aspect of the present invention, there is provided a color conversion method of a light emitting pointer for a vehicle dashboard, which comprises the steps of: disposing three color light sources having three colors arranged at equal intervals on the circumferences thereof centering around the axis of the pointer; and controlling the switching of the respective light sources, such that the light having the three colors from the respective light sources is emitted for predetermined time on the different time, whereby the combination of the three colors using the afterimage of the eyes is induced to thus obtain various colors.

According to another aspect of the present invention, there is provided a color conversion device of the light emitting pointer for the vehicle dashboard, which comprises: the light emitting pointer formed as a unitary body with a light receiving prism; three light sources having three colors arranged at equal intervals on the circumferences thereof centering around the axis of the pointer; and a light source operation controller (e.g., a microprocessor) connected to the respective light sources, for controlling the switching of the respective light sources.

### BRIEF DESCRIPTION OF THE DRAWINGS

FIG. 1 is a plan view illustrating a color conversion device of a light emitting pointer for a vehicle dashboard according to an embodiment of the present invention;

FIG. 2 is a longitudinal sectional view of FIG. 1; and

FIG. 3 is a waveform view illustrating the combination results of the light sources in a time-division manner according to a color conversion method of the present invention.

### DETAILED DESCRIPTION OF THE PREFERRED EMBODIMENT

An explanation of a preferred embodiment of the present invention will be depicted with reference to the accompanying drawings.

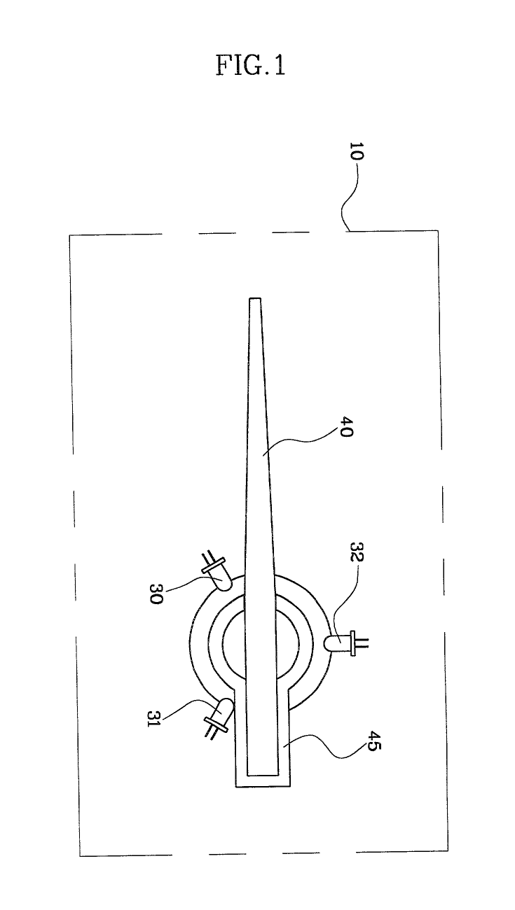

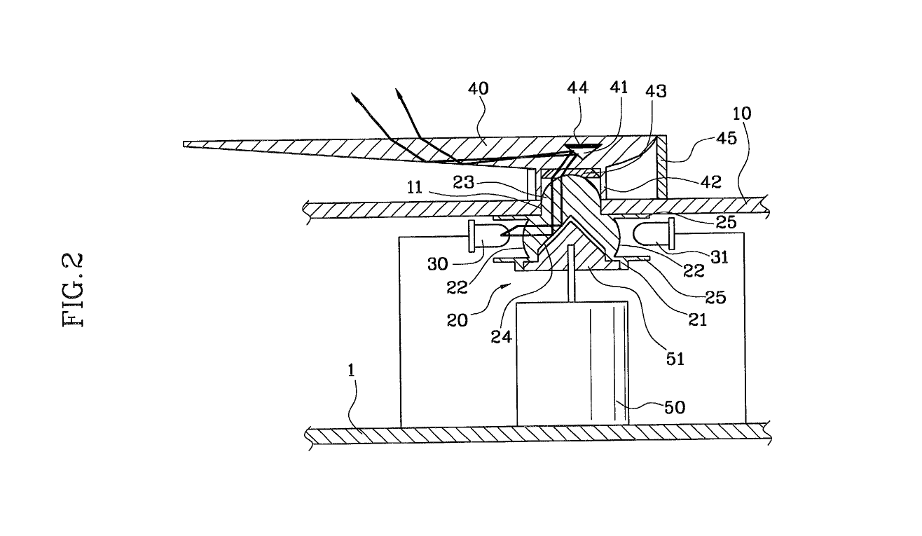

Referring first to a color conversion method of a light emitting pointer for a vehicle dashboard, the pointer exhibits various kinds of color variations, upon operation, as a light receiving prism and light sources of three colors emit respective light thereof in a sequential order on respective corresponding time by on/off combination of the colors in a time-division manner using the afterimage of eyes. As shown in FIGS. 1 and 2, three light sources 30 to 32 of three colors are arranged at equal intervals on the circumferences thereof centering around the axis of the pointer 40, and the switching of the respective light sources 30 to 32 is controlled, such that the light of the three colors from the respective light sources 30 to 32 is emitted for predetermined time on the different time, whereby the combination of the three colors using the afterimage of the eyes is induced to thus obtain various colors.

As shown, a color conversion device of a light emitting pointer for a vehicle dashboard includes the light emitting pointer 40 formed as a unitary body with a light receiving prism 20, light sources A to C 30 to 32 of three colors arranged at equal intervals on the circumferences thereof centering around the axis of the pointer 40 and a light source operation controller (e.g., a microprocessor) connected to the respective light sources 30 to 32, for controlling the switching of the respective light sources 30 to 32.

In more detail, the color conversion device of the present invention includes: a character board 10 on which meter graduations (which are not shown in the drawing) are indicated and forming a through hole 11 through which a driving shaft is inserted on the center thereof, the pointer 40 of a transparent body formed as a unitary body with a cylindrical boss 42 that is adapted to be inserted through the through hole 11 of the character board 10 and having a second reflection prism 41 for refracting light in the interior of the body thereof; the light receiving prism 20 disposed on the rear side of the character board 10 for vertically refracting the light incident on the side thereof and assembled as a unitary body in the interior of the boss 42 of the pointer 40; the light sources A to C 30 to 32 connected to a printed circuit board 1 and arranged at equal intervals on the circumferences thereof on the side of the light receiving prism 20; a motor 50 disposed on the rear surface of the character board 10 on the axis of the pointer 40; and an axis connecting plate 51 interposed between the motor 50 and the light receiving prism 20 for connecting them as a unitary body with each other.

The light receiving prism 20 is comprised of: two disc parts 25 formed in parallel at a predetermined interval; a light receiving part 22 formed convexly between the two disc parts 25 along the peripheries of the two disc parts; a light transmitting part 23 formed convexly on the outside of the one side disc part 25, the light transmitting part inserted to the inside of the boss 42 of the pointer 40; a connecting part 21 formed on the outside of the other side disc part 25, into which the axis connecting plate 51 is inserted and coupled; and a first reflection part 24 formed on the inside of the connecting part 21, for reflecting the light incident through the light receiving part 22 to the light transmitting part 23.

A condensing lens 43, which condenses the light refracted by the first reflection part 24 of the light receiving prism 20 to project the condensed light to the second reflection prism 41, is formed in the inside of the boss 42 of the pointer 40, while being close to the light receiving prism 20.

The second reflection prism 41 is provided, on the outside thereof, with a diffused reflection preventing lens 44 that is adapted to reflect the light projected through the condensing lens 43 only in one direction, that is, to the direction of the pointer 40 body, in order to prevent the emission of the light to another direction.

Also, the pointer 40 is provided with a cap 45 that is adapted to cover the end portion thereof, for the purpose of condensing the light reflected through the second reflection prism 41 to the body side thereof.

On the other hand, the light sources 30 to 32 are embodied with a typical light emitting diode (LED) and preferably connected to the printed circuit board 1 by means of separate drawing wires, such that they are disposed close to the light receiving part 22 of the light receiving prism 20.

Under the above construction, an explanation of the principle of the operation of the light emitting pointer of the present invention will be discussed.

The light emitting diodes (the light sources A to C) 30 to 32 having red, green and blue colors corresponding to the three primary colors of the light are used as the light sources having the three colors, and after the light sources 30 to 32 are divided by predetermined time relative to repeated predetermined period, they are sequentially turned on/off one by one, such that the colors are combined.

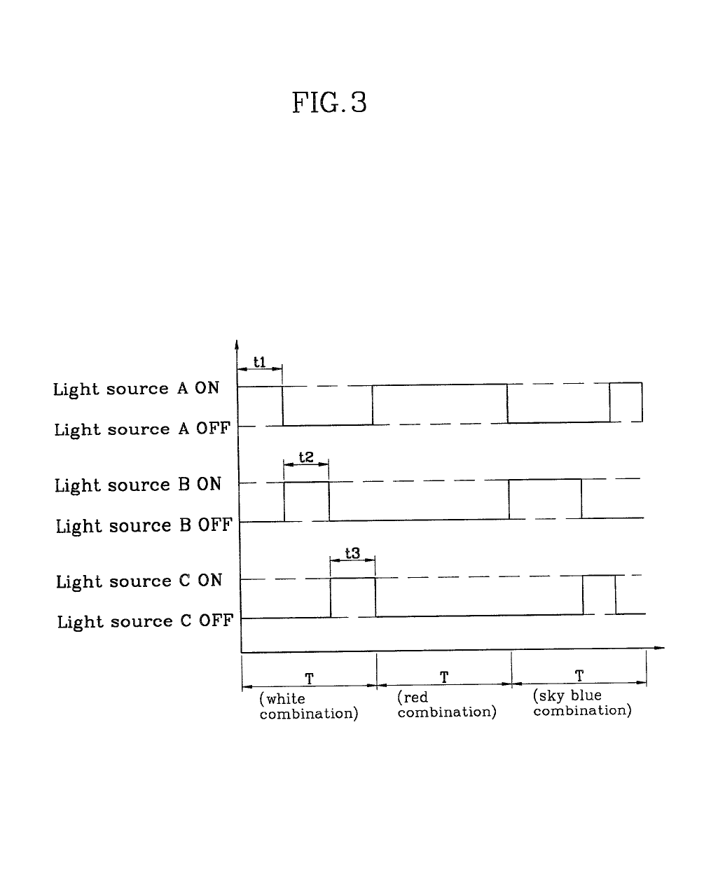

That is, it is assumed that a period is set to ‘T’ and the divided time for the respective light sources is set to ‘t1, t2 and t3’, as shown in FIG. 3, the combination of a white color is made in such a manner that the red, green and blue light sources are turned on/off sequentially by the time divided equally under the control of the microprocessor.

Of course, if only the red color is to be exhibited, only the red light source 30 operates during the period T, and if a compound color such as a sky blue color is to be exhibited, the green, blue and red light sources are turned on/off sequentially by different time intervals, as shown in FIG. 3. In all cases, however, only one light source should be lighted up on the same time, and in addition to the three colors, the combination of various colors may be made, if minute time division is set by the microprocessor. This is not made in an analog control manner, but made in a digital control manner, such that the uniform characteristics of the product can be achieved, irrespective of the dispersion of the characteristics of the part components.

At this time, even if the light of the respective light sources is differently distributed to the pointer, the light of the different colors is not emitted on the same time, such that the color of the pointer is uniformly exhibited. Thus, even in the case where the visual point of the driver is close to the pointer 40, he can sense the uniform color on the pointer 40.

The above principle is really applicable. In other words, when the principle of the present invention is applied to a vehicle with a black face meter board, a clear visual field can be ensured. Specifically, in the case where the colors of the pointer are converted into white, sky blue and red colors in a named order in accordance with the speed variation, for example, to low, intermediate and high speeds, on a speedometer board, the operation order and division time of the respective light sources are inputted to the microprocessor, in the same manner as above. This enables the driver of the vehicle to instinctively and intuitively recognize the speed variation in the visual respect. So, warning to the speed variation can be given to the driver and the tediousness of the driver caused during driving can be removed.

On the other hand, the principle of the light emission of the pointer of the present invention will be hereinafter followed. According to a light emitting pointer device for a vehicle dashboard of the present invention, the light projected in a horizontal direction from the light sources 30 to 32 is incident on the light receiving part 22 of the light receiving prism 20 and then refracted perpendicularly by the first reflection part 24. Next, the light refracted moves along the interior of the light receiving prism 20 and is then emitted through the light transmitting part 23. After that, the light emitted is refracted to the second reflection prism 41 by means of the condensing lens 43.

The light is refracted again in the second reflection prism 41 by means of the inside of the body of the pointer 40 and then emitted to the outside. At this time, the path of light emitted is formed only on the inside of the body of the pointer 40 by means of the diffused reflection preventing lens 44 disposed on the outside of the second reflection prism 41, thereby obtaining the pointer 40 that is emitted with a high luminance.

Accordingly, the driver can continuously observe the pointer 40 that is emitted uniformly and vividly during driving.

The present invention has a closed type of structure where the light that is incident on the light receiving prism 20 is not emitted to the outside, and since the whole of the light receiving prism 20 serves as the light source, there is no possibility that the light emitting state on the pointer 40 is not uniform due to the positions or number of the light sources 30 to 32. Particularly, the reflection path of the light is remarkably shortened to thereby minimize the undesirable light emission to the outside, such that when compared as in the existing device, the condensing performance according to the present invention can be more improved. For reference, the reflection path of the light is shown by a heavy solid line in FIG. 3.

Moreover, the present invention is not limited to the above-discussed structure and is applicable to various pointer devices.

As set forth in the above, a light emitting pointer device for a vehicle dashboard according to the present invention is capable of forming a pointer and a prism as a unitary body with each other, in order to dispose light sources close to the pointer, whereby the light projected from the light sources disposed on the rear side of a character board of the dashboard efficiently reaches the body of the pointer, without any dispersion. Also, the light emitting pointer device is capable of forming a closed type structure where the outside of the prism is closed by virtue of a boss and a cap, in order to project the light emitted from the light sources in one direction through the prism, whereby the light from the light sources is mostly emitted in the direction of the body of the pointer, thereby obtaining the pointer with a high luminance, which enables a driver during driving at night to clearly observe the graduations on the dashboard.

More particularly, the pointer exhibits various kinds of color variations, upon operation, as the light receiving prism and the light sources of three colors emit the respective light in a sequential order on respective corresponding time by on/off combination of the colors in a time-division manner using the afterimage of eyes, thereby improving the recognition of the vehicle state and enhancing a level of the vehicle.

While the present invention has been described with reference to a preferred embodiment, the description is illustrative of the invention and is not to be construed as limiting the invention. Various modifications may occur to those skilled in the art without departing from the true spirit and scope of the invention as defined by the appended claims.

What is claimed is:

1. A color conversion method of a light emitting pointer for a vehicle dashboard, the method comprising the steps of:
disposing three light sources having three colors arranged at equal intervals on the circumferences thereof centering around the axis of the light emitting pointer; and
controlling the switching of the respective light sources, such that the light of the three colors from the respective light sources is emitted for predetermined time on the different time, whereby the combination of the three colors using the afterimage of the eyes is induced to thus obtain various colors.

2. The color conversion method according to claim 1, wherein the light sources are used with light emitting diodes having red, green and blue colors, and after the light sources are divided by predetermined time repeated in predetermined period, the light sources are sequentially turned on/off one by one, such that the colors are combined.

3. The color conversion method according to claim 1, wherein the color of the light emitting pointer obtained by the color combination of the light sources, which is turned on/off, is determined upon the driving speed of the vehicle.

4. A color conversion device of a light emitting pointer for the vehicle dashboard, the device comprising:
the light emitting pointer formed as a unitary body with a light receiving prism;
three light sources having three colors arranged at equal intervals on the circumferences thereof centering around the axis of the light emitting pointer; and
a light source operation controller connected to the respective light sources, for controlling the switching of the respective light sources.

5. A light emitting pointer device for the vehicle dashboard, the device comprising:
a character board on which meter graduations are indicated and forming a through hole through which a driving shaft is inserted on the center thereof;
a pointer of a transparent body formed as a unitary body with a cylindrical boss that is adapted to be inserted through the through hole of the character board and having a second reflection prism for refracting light in the interior of the body thereof;
a prism disposed on the rear side of the character board for vertically refracting the light incident on the side thereof and assembled as a unitary body in the interior of the boss of the pointer;
light sources having three colors connected to a printed circuit board and arranged at equal intervals on the circumferences thereof on the side of the prism;
a motor disposed on the rear surface of the character board on the axis of the pointer; and
an axis connecting plate interposed between the motor and the prism for connecting the motor and the prism as a unitary body with each other.

6. The light emitting pointer device according to claim 5, wherein the prism is comprised of: two disc parts formed in parallel at a predetermined interval; a light receiving part formed convexly between the two disc parts along the peripheries of the two disc parts; a light transmitting part formed convexly on the outside of the one side disc part, the light transmitting part inserted to the inside of the boss of the pointer; a connecting part formed on the outside of the other side disc part, into which the axis connecting plate is inserted and coupled; and a first reflection part formed on the inside of the connecting part, for reflecting the light incident through the light receiving part to the light transmitting part.

7. The color conversion method according to claim 2, wherein the color of the light emitting pointer obtained by the color combination of the light sources, which is turned on/off, is determined upon the driving speed of the vehicle.
